(19) United States
(12) Patent Application Publication
(10) Pub. No.: US 2026/0262032 A1
(43) Pub. Date: Sep. 3, 2026

(54) SCHEDULE PROCESSING METHOD AND COMMUNICATION DEVICE

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 19/164,021

(22) PCT Filed: Mar. 13, 2023
(86) PCT No.: PCT/CN2023/081046

§ 371 Date: Sep. 10, 2025

(51) Int. Cl. H04W 72/121; H04L 12/18; H04W 72/232

(52) U.S. Cl. CPC H04W 72/121; H04L 12/1877; H04W 72/232

(57) ABSTRACT

Embodiments of the present disclosure relate to a schedule processing method, when can be implemented as an apparatus, a system, a communication device, or a storage medium. The schedule processing method is executed by a network device. The schedule processing method includes sending first information. The first information is used for scheduling two terminals to send uplink data.

### CROSS-REFERENCE

The present application is a U.S. National Stage of International Application No. PCT/CN2023/081046, filed on Mar. 13, 2023, the entire content of which is incorporated herein by reference for all purposes.

### TECHNICAL FIELD

The present disclosure relates to a field of wireless communication technologies, and more particularly, to a schedule processing method, an apparatus, a system, a communication device, and a non-transitory storage medium.

### BACKGROUND

With the continuous development of wireless communication technologies, network devices are capable of implementing an increasing number of functions; for example, the network devices may implement scheduling for terminals.

### SUMMARY

Embodiments of the present disclosure provide a schedule processing method, an apparatus, a system, a communication device, and a non-transitory storage medium.

According to a first aspect of the embodiments of the present disclosure, a schedule processing method is provided, performed by a network device, including:
sending first information, where the first information is configured to schedule at least two terminals to send uplink data.

According to a second aspect of the embodiment of the present disclosure, a schedule processing method is provided, performed by a terminal, including:
acquiring first information, where the first information is configured to schedule at least two terminals to send uplink data.

According to a third aspect of the embodiment of the present disclosure, a communication device is provided, including:
one or a plurality of processors;
where the processor is configured to call computer instructions such that the communication device executes the schedule processing method as described in the first aspect or second aspect, or in the optional implementations of the first aspect and second aspect.

### BRIEF DESCRIPTION OF THE DRAWINGS

In order to more clearly illustrate the technical solutions in the embodiments of the present disclosure, the drawings required for describing the embodiments are introduced below. The following drawings are merely some embodiments of the present disclosure and do not impose specific limitations on the scope of protection of the present disclosure.

FIG. 1 is a schematic structural diagram of a schedule processing system according to embodiments of the present disclosure.

FIG. 2 is a schematic interaction diagram of a schedule processing method according to embodiments of the present disclosure.

FIG. 3a is a schematic flow diagram of a schedule processing method according to embodiments of the present disclosure.

FIG. 3b is a schematic flow diagram of a schedule processing method according to embodiments of the present disclosure.

FIG. 3c is a schematic flow diagram of a schedule processing method according to embodiments of the present disclosure.

FIG. 3d is a schematic flow diagram of a schedule processing method according to embodiments of the present disclosure.

FIG. 4a is a schematic flow diagram of a schedule processing method according to embodiments of the present disclosure.

FIG. 4b is a schematic flow diagram of a schedule processing method according to embodiments of the present disclosure.

FIG. 4c is a schematic flow diagram of a schedule processing method according to embodiments of the present disclosure.

FIG. 4d is a schematic flow diagram of a schedule processing method according to embodiments of the present disclosure.

FIG. 4e is a schematic flow diagram of a schedule processing method according to embodiments of the present disclosure.

FIG. 5 is a schematic flow diagram of a schedule processing method according to embodiments of the present disclosure.

FIG. 6a is a schematic structural diagram of a first schedule processing apparatus according to embodiments of the present disclosure.

FIG. 6b is a schematic structural diagram of a second schedule processing apparatus according to embodiments of the present disclosure.

FIG. 7a is a schematic structural diagram of a communication device provided according to embodiments of the present disclosure.

FIG. 7b is a schematic structural diagram of a chip provided according to embodiments of the present disclosure.

### DETAILED DESCRIPTION

The scheduling of a terminal by a network device needs to address the problem of scheduling overhead.

Embodiments of the present disclosure provide a schedule processing method, an apparatus, a system, a communication device, and a non-transitory storage medium.

In a first aspect, an embodiment of the present disclosure provides a schedule processing method, performed by a network device, including: sending first information, where the first information is configured to schedule at least two terminals to send uplink data.

In the above embodiment, a network device may schedule a plurality of terminals to send the uplink data by sending one piece of first information, thereby reducing the number of times the network device sends the first information and lowering the overhead of downlink resources. Moreover, the scheduling method in the embodiment of the present disclosure may be adapted to the network with high terminal connection density.

In combination with some embodiments of the first aspect, in some embodiments, sending the first information includes one of:
broadcasting the first information;
multicasting the first information.

In the above solution, the first information may be sent via broadcasting such that all terminals within a cell may receive the first information, thereby facilitating the scheduling of one, a plurality of, or all terminals within the cell to send the uplink data. Alternatively, the first information may be sent via multicasting such that a group of terminals may receive the first information, thereby facilitating the scheduling of one, a plurality of, or all terminals in the group of terminals to send the uplink data.

In combination with some embodiments of the first aspect, in some embodiments, sending the first information includes: sending first Downlink Control Information (DCI), where the first DCI includes the first information.

In the above solution, the first information may be sent via the first DCI, enabling reuse of an existing signaling to send the first information and reducing the signaling overhead.

In combination with some embodiments of the first aspect, in some embodiments, a Cyclic Redundancy Check (CRC) of the first Downlink Control Information (DCI) uses an identity for scrambling.

In the above solution, by using the identity for scrambling the CRC of the first DCI, only the terminal with the identity may successfully descramble the first DCI, thereby achieving scheduling of the terminal with the identity.

In combination with some embodiments of the first aspect, in some embodiments, the identity is one of the following:
a group identity, where the group identity is configured to indicate a group of terminals corresponding to the first DCI, where at least two terminals are divided into one or a plurality of groups; or
a broadcast identity.

In the above solution, by using the group identity for scrambling the CRC of the first DCI, the group of terminals indicated by the group identity may be accurately scheduled to send the uplink data; alternatively, by using the broadcast identity for scrambling the CRC of the first DCI, all terminals in the cell may be accurately scheduled to send the uplink data.

In combination with some embodiments of the first aspect, in some embodiments, the first information includes second information, where the second information is configured to indicate at least one of the following:
one group or a plurality of groups of terminals requiring scheduling; or
the terminal requiring scheduling.

In the above embodiment, it is possible to accurately determine the terminal actually scheduled to send the uplink data within a group of terminals, or accurately determine at least one group of terminals and/or at least one terminal actually scheduled to send the uplink data within the cell.

In combination with some embodiments of the first aspect, in some embodiments, the terminal is in a Radio Resource Control (RRC) connected state.

In the above embodiments, it is possible to implement scheduling for a plurality of terminals in the RRC connected state, thereby improving the success rate of scheduling by the network device.

In combination with some embodiments of the first aspect, in some embodiments, sending the first information includes: sending the first information based on a downlink data channel.

In the above embodiment, the first information may be sent via the downlink data channel, thus reducing signaling overhead.

In combination with some embodiments of the first aspect, in some embodiments, before sending the first information, further including: sending second DCI, where the second DCI is configured to schedule the downlink data channel.

In the above embodiment, the downlink data channel for sending the first information may be scheduled through the downlink control information, which provides a method for scheduling the transmission of the first information; and the existing signaling may be reused to reduce the signaling overhead.

In combination with some embodiments of the first aspect, in some embodiments, the downlink data channel carries at least one of the following:
terminal identities of at least two terminals scheduled;
a group identity of one group of terminals scheduled or group identities of a plurality of groups of terminals scheduled.

In the above solution, the downlink data channel may carry terminal identities of the terminals that need to be scheduled or a group identity of the groups of terminals that need to be scheduled. On the one hand, the existing signaling may be reused to send these identities, without additional signaling to send these identities, thereby reducing signaling overhead; on the other hand, the terminals that need to be scheduled may be indicated when the first information is sent, enabling the terminals to respond to the scheduling of the first information in a timely manner and thus reducing communication latency.

In combination with some embodiments of the first aspect, in some embodiments, the first information is configured to determine one of the following:
an uplink transmission resource for the terminal to send the uplink data;
a resource pool for the terminal to send the uplink data.

In the above solution, a resource pool or an uplink transmission resource for the terminal to send the uplink data may be configured, which is beneficial for the terminal to send the uplink data on an appropriate resource pool or uplink transmission resource, thereby improving the communication quality of wireless communication.

In combination with some embodiments of the first aspect, in some embodiments, the method further includes: sending a high layer signaling; the high layer signaling is used to configure a resource pool for the terminal to send the uplink data; the resource pool is configured to determine the uplink transmission resource.

In the above solution, the network device may configure the resource pool, for sending the uplink data, to the terminal, such that the terminal is aware of the respective configured resource pool; and the existing high layer signaling may be reused to reduce signaling overhead.

In combination with some embodiments of the first aspect, in some embodiments, one terminal is configured with one or a plurality of resource pools.

In the above solution, the resource pool for sending uplink data may be flexibly configured for the terminal.

In combination with some embodiments of the first aspect, in some embodiments, the resource pools configured for the at least two terminals are at least partially identical or entirely different.

In the above solution, the resource pools for sending the uplink data may be flexibly configured for a plurality of terminals.

In combination with some embodiments of the first aspect, in some embodiments, the first information includes third information; the third information is configured to indicate a time-domain offset between a first time-domain position and a second time-domain position; the first time-domain position is a position of a time unit where the first information is sent; the second time-domain position is a position of a time unit of the resource pool for the terminal to send the uplink data.

In the above solution, the network device may configure the time-domain offset for the terminal, such that the terminal may accurately determine the resource pool for sending the uplink data based on the time-domain offset.

In combination with some embodiments of the first aspect, in some embodiments, the first information includes fourth information, where the fourth information is configured to indicate one of:
at least one resource pool, selected from preconfigured resource pools, for at least one terminal to send the uplink data; or
at least one uplink transmission resource, selected from preconfigured resource pools, for at least one terminal to send the uplink data.

In the above solution, the terminal may be configured, by directly indicating, with a resource pool selected from the preconfigured resource pools for sending the uplink data, or with an uplink transmission resource selected from preconfigured resource pools for sending the uplink data.

In combination with some embodiments of the first aspect, in some embodiments, the method includes: sending configuration information, where the configuration information includes fifth information; the fifth information is configured to indicate the uplink transmission resource in the resource pool corresponding to at least one terminal.

In the above solution, the network device may configure the fifth information for the terminal, such that the terminal is aware of the corresponding relationship between the resource pool and the uplink transmission resource, thereby enabling the terminal to accurately determine the uplink transmission resource for sending uplink data based on the resource pool and the fifth information.

In a second aspect, the embodiments of the present disclosure provide a schedule processing method, performed by a terminal, including: acquiring first information, where the first information is configured to schedule at least two terminals to send uplink data.

In combination with some embodiments of the second aspect, in some embodiments, acquiring the first information includes one of the following:
acquiring the first information that is broadcast; or
acquiring the first information that is multicast.

In combination with some embodiments of the second aspect, in some embodiments, acquiring the first information includes: acquiring first DCI, where the first DCI includes the first information.

In combination with some embodiments of the second aspect, in some embodiments, the CRC of the first DCI uses an identity for scrambling.

In combination with some embodiments of the second aspect, in some embodiments, the identity is one of the following:
a group identity, where the group identity is configured to indicate a group of terminals corresponding to the first DCI, and the at least two terminals are divided into one group or a plurality of groups; or
a broadcast identity.

In combination with some embodiments of the second aspect, in some embodiments, the first information includes second information; where the second information is configured to indicate at least one of the following:
one or a plurality of groups of terminals requiring scheduling; or
the terminal requiring scheduling.

In combination with some embodiments of the second aspect, in some embodiments, the terminal is in an RRC connected state.

In combination with some embodiments of the second aspect, in some embodiments, acquiring the first information includes: acquiring the first information sent based on a downlink data channel.

In combination with some embodiments of the second aspect, in some embodiments, before acquiring the first information, the method further includes: acquiring second DCI, where the second DCI is configured to schedule the downlink data channel.

In combination with some embodiments of the second aspect, in some embodiments, the downlink data channel carries at least one of the following:
terminal identities of at least two terminals scheduled; or
a group identity of one group of terminals scheduled or group identities of a plurality of groups of terminals scheduled.

In combination with some embodiments of the second aspect, in some embodiments, the method includes one of the following:
determining, based on the first information, an uplink transmission resource for the terminal to send the uplink data; or
determining, based on the first information, a resource pool for the terminal to send the uplink data.

In combination with some embodiments of the second aspect, in some embodiments, the method further includes: receiving a high layer signaling, where the high layer signaling is used to configure a resource pool for the terminal to send the uplink data; the resource pool is configured to determine an uplink transmission resource.

In combination with some embodiments of the second aspect, in some embodiments, one terminal is configured with one or a plurality of resource pools.

In combination with some embodiments of the second aspect, in some embodiments, the resource pools configured for the at least two terminals are at least partially identical or entirely different.

In combination with some embodiments of the second aspect, in some embodiments, the first information includes third information; the third information is configured to indicate a time-domain offset between a first time-domain position and a second time-domain position; the first time-domain position is a position of a time unit in which the first information is sent; the second time-domain position is a position of a time unit of the resource pool for the terminal to send the uplink data.

In combination with some embodiments of the second aspect, in some embodiments, the first information includes fourth information, where the fourth information is configured to indicate one of the following:
at least one resource pool, selected from preconfigured resource pools, for at least one terminal to send the uplink data; or
at least one uplink transmission resource, selected from preconfigured resource pools, for at least one terminal to send the uplink data.

In combination with some embodiments of the second aspect, in some embodiments, determining the uplink transmission resource for the terminal to send the uplink data based on the first information includes: determining the uplink transmission resource for the terminal to send the uplink data based on the resource pool and fifth information, where the fifth information is configured to indicate the uplink transmission resource in the resource pool corresponding to at least one terminal.

In the above solution, the terminal may accurately determine the uplink transmission resource for sending the uplink data based on the resource pool and the fifth information.

In combination with some embodiments of the second aspect, in some embodiments, the method further includes at least one of the following:
receiving configuration information sent by a network device, where the configuration information includes the fifth information; or
determining the fifth information based on a protocol agreement.

In the above solution, the terminal may acquire the fifth information indicating the corresponding relationship between the resource pool and the uplink transmission resource through various ways.

In a third aspect, the embodiments of the present disclosure provide a first schedule processing apparatus, including: a sending module, configured to send first information, where the first information is configured to schedule at least two terminals to send uplink data.

In a fourth aspect, the embodiments of the present disclosure provide a second schedule processing apparatus, including: a receiving module, configured to acquire first information, where the first information is configured to schedule at least two terminals to send uplink data.

In a fifth aspect, the embodiments of the present disclosure provide a schedule processing system, where the schedule processing system includes a network device and a terminal; where the network device is configured to perform the schedule processing method of the network device, and the terminal is configured to perform the schedule processing method of the terminal.

In a sixth aspect, the embodiments of the present disclosure provide a communication device, including:
one or a plurality of processors;
where the processor is configured to invoke computer instructions to cause the communication device to execute the schedule processing method as described in the optional implementations of the first aspect or the second aspect, or both the first and second aspects.

In a seventh aspect, the embodiments of the present disclosure provide a program product, which, when executed by the communication device, causes the communication device to perform the method as described in the optional implementations of the first aspect and the second aspect.

In an eighth aspect, the embodiments of the present disclosure provide a non-transitory computer-readable storage medium, where the non-transitory computer-readable storage medium stores computer instructions, and when the computer instructions are run on a communication device, the communication device is caused to execute the schedule processing method as described in the optional implementations of the first aspect, or the second aspect, or the first and second aspects.

It may be understood that the above-mentioned first schedule processing apparatus, the second schedule processing apparatus, the communication device, and the non-transitory computer-readable storage medium are all used to perform the methods provided in the embodiments of the present disclosure. Therefore, the beneficial effects they may achieve may be referred to the corresponding beneficial effects in the methods.

The embodiments of the present disclosure provide the schedule processing method, the apparatus and the system, the communication device, and the non-transitory storage medium. In some embodiments, the terms in the schedule processing method may be used interchangeably with information processing method, communication method, and the like. The terms in the schedule processing apparatus may be used interchangeably with information processing apparatus, communication device, and the like. The terms in the schedule processing system may be used interchangeably with information processing system, communication system, and the like.

The embodiments of the present disclosure are not exhaustive and are only illustrative of some embodiments, and are not intended as specific limitations on the scope of protection of the present disclosure. Under non-conflicting circumstances, each step in a certain embodiment may be implemented as an independent embodiment, and the respective steps may be combined in any way. For example, a solution with certain steps removed in one embodiment may also be implemented as an independent embodiment; the order of the steps in an embodiment may also be arbitrarily changed. In addition, the optional implementations in one embodiment may be arbitrarily combined; furthermore, the respective embodiments may be arbitrarily combined, for example, part or all of the steps of different embodiments may be arbitrarily combined, and one embodiment may be arbitrarily combined with the optional implementations of other embodiments.

The terms used in the embodiments of the present disclosure are merely for the purpose of describing particular embodiments, and are not intended to limit the present disclosure.

In the embodiments of the present disclosure, singular expressions such as “a”, “an”, “the”, “said”, “aforementioned”, “this”, etc., also include plural expressions unless explicitly indicated otherwise in the context. The term “a plurality of” in the embodiments of the present disclosure refers to two or more than two. The prefixes “first”, “second”, etc., used in the embodiments of the present disclosure are only for distinguishing different described objects, and do not impose limitations on the position, order, priority, quantity, or content of the described objects. The description of the described objects should be interpreted based on the context in the claims or embodiments, and the use of ordinal numbers should not be construed as adding unnecessary limitations. For example, if the described object is “field”, then the ordinal numbers preceding “field” in “first field” and “second field” do not limit the position or sequence between the fields. “First” and “second” do not restrict whether the modified “fields” are in the same message, nor do they restrict the order between the “first field” and the “second field”. For another example, if the described object is “level”, the ordinal numbers before “level” in “first field” and “second field” do not limit the priority between the “levels”. Furthermore, the quantity of the described object is not restricted by the ordinal numbers. “First field” and “second field” may each represent one or a plurality of “levels”. For example, “first apparatus” may refer to one or a plurality of apparatuses. In addition, objects modified by different prefix words may be the same or different. For example, if the described object is “apparatus”, then “first apparatus” and “second apparatus” may be the same apparatus or different apparatuses, and their types may be the same or different. For another example, if the described object is “information”, then “first information” and “second information” may be the same information or different information, and their contents may be the same or different.

In the embodiments of the present disclosure, expressions such as “at least one of A, B, C . . . ” or “A and/or B and/or C . . . ” include any individual one of A, B, C . . . , as well as any combination of two or more of A, B, C . . . , with each case being considered as a possible scenario. For example, “at least one of A, B, and C” includes: only A, only B, only C, a combination of A and B, a combination of A and C, a combination of B and C, and a combination of A, B, and C. Likewise, “A and/or B” includes only A, only B, and the combination of A and B.

In some embodiments, expressions such as “in one case A, in another case B”, or “in response to one case A, in response to another case B”, may, depending on the situation, include the following technical solutions: executing A regardless of B, i.e., in some embodiments A; executing B regardless of A, i.e., in some embodiments B; selectively executing A and B, i.e., in some embodiments choosing to execute one from A and B; executing both A and B, i.e., in some embodiments, both A and B are executed. Similar logic applies when there are more branches, such as A, B, C, and so on.

In some embodiments, expressions such as “including A”, “containing A”, “configured to indicate A”, or “carrying A”, may be interpreted as directly carrying A, or indirectly indicating A.

In some embodiments, terms such as “in response to . . . ”, “in response to determining . . . ”, “in a case that . . . ”, “when . . . ”, “upon . . . ”, “if . . . ”, “provided that . . . ”, and similar phrases may be used interchangeably. In some embodiments, terms such as “greater than”, “greater than or equal to”, “above”, “higher than”, and “not less than” may be used interchangeably. Likewise, terms such as “less than”, “less than or equal to”, “below”, “lower than”, and “not greater than” may be used interchangeably.

In some embodiments, terms such as “radio”, “wireless”, “Radio Access Network (RAN)”, “Access Network (AN)”, and “RAN-based” may be used interchangeably.

In some embodiments, “predetermined” or “preset” may be interpreted as being pre-defined in a protocol or as a pre-configuration action performed by an apparatus or the like.

In some embodiments, the apparatus and similar entity may be interpreted as physical or virtual, and its name is not limited to those stated in the embodiments. Terms such as “apparatus”, “equipment”, “device”, “network element”, “node”, “function”, “unit”, “entity”, “system”, “chip”, “system on chip”, and “body” may be used interchangeably.

In some embodiments, names of information and similar items are not limited to those stated in the embodiments. Terms such as “information”, “message”, “signaling”, “report”, “indication”, “configuration”, and “data” may be used interchangeably.

In some embodiments, “acquire”, “obtain”, “get”, “receive”, and “transmit (send and/or receive)” may be used interchangeably, and may refer to receiving from other entities, obtaining from a protocol, or obtaining through self-processing, among other meanings.

In some embodiments, “send”, “report”, “issue”, and “transmit (send and/or receive)” may be used interchangeably.

In some embodiments, data and information may be acquired in accordance with the laws and regulations of the country or region in which they are located.

In some embodiments, data and information may be acquired upon obtaining user consent.

Furthermore, in the embodiments of the present disclosure, each element, each row, or each column of the tables may be implemented as an independent embodiment. Any combination of elements, rows, or columns may also be implemented as an independent embodiment.

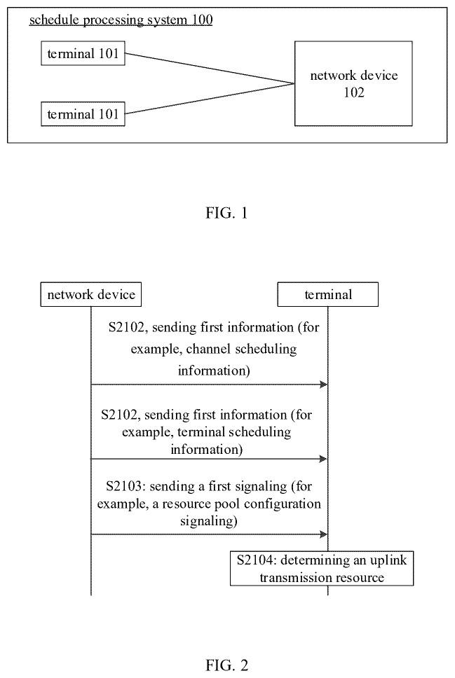

FIG. 1 is a schematic structural diagram of a schedule processing system 100 according to an embodiment of the present disclosure. As shown in FIG. 1, the schedule processing system 100 may include one or more terminals 101 and a network device 102.

In some embodiments, the terminal 101 includes at least one of the following: a terminal device, a User Equipment (UE), a mobile phone, a wearable device, a vehicle, an Internet of Things (IoT) terminal, such as a sensor device, a mobile phone (also referred to as “cellular” phone), and a computer equipped with an IoT terminal, a Station (STA), a subscriber unit, a subscriber station, a mobile station, a mobile, a remote station, an access point, a remote terminal, an access terminal, a user device, and a user agent.

Optionally, the terminal 101 includes at least one of the following: fixed, portable, pocket-sized, handheld, computer-integrated, or in-vehicle apparatus.

Optionally, the terminal 101 includes at least one of the following: an unmanned aerial vehicle device, an in-vehicle device, a wearable device, or an IoT device.

Optionally, the terminal 101 includes a streetlight, a signal light, or other roadside equipment with wireless communication functions.

Optionally, the terminal 101 includes an in-vehicle computer with wireless communication capabilities or an external wireless communication device connected to an in-vehicle computer.

Optionally, the terminal 101 is an Ambient Internet of Things (Ambient IoT) terminal. Compared to a Narrow Band Internet of Things (NB-IOT) terminal, the Ambient IoT terminal has lower complexity and cost. The main characteristic of the Ambient IoT terminal is that it does not have a battery and is powered by and excited through an electromagnetic signal it receives; or it may have a battery that has limited electric storage capacity, but the battery does not require manual charging and may obtain a small amount of electrical energy from external sources, such as by harvesting electromagnetic waves, thermal energy, kinetic energy, etc., from external sources. Optionally, the Ambient IoT terminal may be applied in an Ambient IoT terminal communication network. Of course, the Ambient IoT terminal may also be applied in any other type of network.

In some embodiments, the network device 102 includes at least one of an access network device and a core network device.

In some embodiments, the access network device is, for example, a base station, but is not limited thereto.

Optionally, the network device 102 is a network node device in an information processing system. The information processing system may be a 4th generation mobile communication (4G) system, also known as Long Term Evolution (LTE) system; or, the information processing system may be a 5G system, also known as new radio (NR) system or 5G NR system. Alternatively, the information processing system may also be a subsequent generation system after the 5G system. The access network in the 5G system may be referred to as the New Generation-Radio Access Network (NG-RAN).

Optionally, the base station includes at least one of the following: 3G base station, 4G base station, 5G base station, or other evolved base stations.

The following embodiments of the present disclosure may be applied to the schedule processing system 100 shown in FIG. 1, or part of its entities, but are not limited thereto. The entities shown in FIG. 1 are illustrative; the schedule processing system may include all or some of the entities in FIG. 1, and may also include other entities not shown in FIG. 1. The number of each entity is arbitrary. The connection relationships between entities are illustrative; the entities may be unconnected or connected, and the connections may be in any form, including direct or indirect connections, wired or wireless connections.

In the embodiments of the present disclosure, the network device 102 may schedule one terminal via one signaling. In this case, scheduling a plurality of terminals requires a plurality of signalings.

FIG. 2 is a schematic interaction diagram of a schedule processing method according to an embodiment of the present disclosure. As shown in FIG. 2, the embodiment of the present disclosure relates to a schedule processing method, which is used in a schedule processing system 100. The method includes steps S2101-S2104: step S2101, the network device sends sixth information to the terminal.

In some embodiments, the terminal receives the sixth information sent by the network device.

In some embodiments, the sixth information is, for example, channel scheduling information.

In some embodiments, the sixth information is configured to schedule a downlink data channel. Optionally, the downlink data channel is configured to send the first information.

In some embodiments, the sixth information is a second DCI. Optionally, the second DCI may refer to DCIs of various formats; for example, the second DCI may include at least one of the following: DCI 0, DCI 1, DCI 1_0, DCI 2, or DCI X; where X is an integer.

In some embodiments, the downlink data channel is a Physical Downlink Shared Channel (PDSCH). Optionally, the PDSCH carries the first information.

As an example, the network device sends a second DCI to the terminal, for scheduling a downlink data channel to send first information. For example, the network device sends the downlink data channel to the terminal, the downlink data channel includes first information, and the first information is configured to schedule at least two terminals to send uplink data.

In some embodiments, the downlink data channel carries at least one of the following: terminal identities of at least two terminals that are scheduled, a group identity of one group of terminals that are scheduled, and group identities of a plurality of groups of terminals that are scheduled.

Optionally, the terminal identity may include at least one of the following: Subscription Concealed Identifier (SUCI), User Information identity (User Info ID), User Application Layer ID, or Globally Unique Temporary Identity (GUTI). Alternatively, the terminal identity may include at least one of any number or index indicating the terminal.

Optionally, the group identity of the terminal may include at least one of any number or index indicating a group of terminals.

Step S2102, the network device sends first information to the terminal.

In some embodiments, the terminal receives the first information sent by the network device.

In some embodiments, the first information is, for example, terminal scheduling information.

In some embodiments, the first information is configured to schedule at least two terminals to send uplink data.

In some embodiments, the first information is configured to schedule each of the at least two terminals to send at least one uplink data. As an example, the first information is configured to schedule at least two terminals; one of the scheduled terminals at least sends one or a plurality of uplink data.

Optionally, the uplink data includes at least one of the following: uplink information or uplink signaling.

In some embodiments, the network device sends the first information to the terminal, including: broadcasting the first information. Optionally, the terminal receives the first information broadcasted by the network device.

In some embodiments, the network device sends the first information to the terminal, including: multicasting the first information. Optionally, the terminal receives the first information that is multicast by the network device.

In some embodiments, the network device sends the first information to the terminal, including: the network device sends the first information based on a downlink data channel. As an example, the network device sends a downlink data channel to the terminal, and the downlink data channel carries the first information.

In some embodiments, the network device sends the first information to the terminal, including: the network device sends a first DCI to the terminal, and the first DCI includes the first information.

Optionally, the first DCI may refer to various formats of DCI; for example, the first DCI may include at least one of the following: DCI 0, DCI 1, DCI 1_0, DCI 2, or DCI X; where X is an integer.

In some embodiments, the network device sends downlink information other than the first DCI to the terminal, and the downlink information may include the first information.

Optionally, the CRC of the first DCI uses an identity for scrambling. Optionally, the CRC may be one or a plurality of bits.

Optionally, the identity is one of the following: a group identity or a broadcast identity.

Optionally, the group identity is configured to indicate a group of terminals corresponding to the first DCI; the at least two terminals are divided into one or a plurality of groups.

Optionally, the broadcast identity is configured to indicate all terminals in the cell. As an example, the broadcast identity may be predetermined by a protocol, or may be configured by the network device through a broadcast message.

Optionally, the network device broadcasts the first DCI, and the CRC of the first DCI is scrambled with the broadcast identity.

Optionally, the network device multicasts the first DCI, and the CRC of the first DCI is scrambled with the group identity.

As an example, the network device sends the first DCI to the terminal, the first DCI includes the first information, and the CRC of the first DCI is scrambled with a group identity; after receiving the first DCI, the terminal descrambles the first DCI based on the group identity stored in the terminal and performs a CRC check. If the check passes, it is determined that the first information is configured to schedule the terminal to send the uplink data; otherwise, if the check fails, it is determined that the first information is not configured to schedule the terminal to send the uplink data.

As an example, the network device sends the first DCI to the terminal, the first DCI includes the first information, and the CRC of the first DCI is scrambled with a broadcast identity; after receiving the first DCI, the terminal descrambles the first DCI based on the broadcast identity stored in the terminal and performs the CRC check. If the check passes, it is determined that the first information is configured to schedule the terminal to send the uplink data; otherwise, if the check fails, it is determined that the first information is not configured to schedule the terminal to send the uplink data.

Optionally, the first information includes second information; where the second information is configured to indicate at least one of the following: one or a plurality of groups of terminals requiring scheduling; and the terminal requiring scheduling.

Optionally, the network device multicasts the first information; the first information includes the second information, and the second information is configured to indicate one or a plurality of groups of terminals that need to be scheduled.

Optionally, the network device broadcasts the first information; the first information includes the second information, and the second information is configured to indicate one or a plurality of groups of terminals that need to be scheduled and/or terminals that need to be scheduled.

As an example, the bit in the second information indicating one group of terminals may be one bit or a plurality of bits. For example, when one group of terminals corresponds to one bit set in the first information, the bit “1” may indicate that the group of terminals needs to be scheduled, or “0” may indicate that the group of terminals does not need to be scheduled. For another example, when one group of terminals corresponds to two bits set in the first information, “11” may indicate the group of terminals needs to be scheduled, or “00” may indicate the group of terminals does not need to be scheduled.

As an example, the bit in the second information indicating one terminal may be one bit or a plurality of bits. For example, when a terminal corresponds to one bit set in the first information, the bit “1” may indicate that the terminal needs to be scheduled, or “0” may indicate that the terminal does not need to be scheduled. For another example, when a terminal corresponds to three bits set in the first information, “111” may indicate that the terminal needs to be scheduled, or “000” may indicate that the terminal does not need to be scheduled.

As an example, at least one bit in the second information is a first value, which indicates that one or a plurality of groups of terminals are scheduled; or at least one bit in the second information is a second value, which indicates that one or a plurality of groups of terminals are not scheduled. For instance, the second information includes 4 bits, and the 4 bits respectively correspond to 4 groups of terminals; if all 4 bits in the second information are “1”, it indicates all 4 groups of terminals need to be scheduled; or if all 4 bits are “0”, it indicates all 4 groups of terminals do not need to be scheduled; or if the 4 bits are “1100”, it indicates that the first 2 groups of terminals need to be scheduled and the last 2 groups of terminals do not need to be scheduled.

As an example, at least one bit in the second information is a third value, which indicates that at least one terminal is scheduled; or at least one bit in the second information is a third value, which indicates that at least one terminal is not to be scheduled. For instance, the second information includes 4 bits, and the 4 bits respectively correspond to four terminals; if all 4 bits in the second information are “1”, it indicates all 4 terminals need to be scheduled; or if all 4 bits are “0”, it indicates all 4 terminals do not need to be scheduled; or if the 4 bits are “1100”, it indicates that the first 2 terminals need to be scheduled and the last 2 terminals do not need to be scheduled. Optionally, the third value and the fourth value may respectively be the same as the first value and the second value, or the third value and the fourth value may respectively be different from the first value and the second value.

As an example, the network device sends a first DCI to the terminal, where the first DCI includes first information and the CRC of the first DCI is scrambled using a group identity; the first information includes second information, and the second information is configured to indicate one or a plurality of scheduled terminals in the terminal group corresponding to the group identity. For example, if one group includes 16 terminals, the group identity may correspond to these 16 terminals; the second information may then be 16-bit information, where the 16 bits correspond one-to-one to the 16 terminals in the group of terminals; when the bit corresponding to a terminal is set to 1, it indicates that the terminal is scheduled; when the bit is set to 0, it indicates that the terminal is not scheduled. For another example, if a group of terminals includes 16 terminals, and the group identity corresponds to the 16 terminals, then the second information may also be 4-bit information, where the 4 bits indicate 4 groups of terminals among the 16 terminals, each group including one or a plurality of terminals; when the bit corresponding to a terminal group is set to 1, it indicates that the terminal group is scheduled;

when the bit is set to 0, it indicates that the terminal group is not scheduled. For another example, if a group of terminals includes 16 terminals and the group identity corresponds to the 16 terminals, then the second information may also be 4-bit information, where the 4 bits indicate the index of the terminal that has actually been scheduled among the 16 terminals.

As an example, the network device sends a first DCI to the terminal, where the first DCI includes first information and the CRC of the first DCI is scrambled using a broadcast identity; the first information includes second information, and the second information is configured to indicate at least one of the following: one or a plurality of groups of terminals that need to be scheduled; the terminal that needs to be scheduled. For example, the cell includes 8 groups of terminals, different groups are indicated by different group identities; the second information includes 8 bits, each bit corresponding to one group of terminals, and the 8 bits correspond one-to-one to the group identities of the 8 terminal groups; when the bit corresponding to the terminal group is set to 1, it indicates the terminal group is scheduled; when the bit is set to 0, it indicates the terminal group is not scheduled. For another example, if the cell includes 8 groups of terminals, different groups are indicated by different group identities, the second information may include 3 bits, and the 3 bits indicate the group number (the group number may be the aforementioned number) of the actually scheduled terminal group(s) among the 8 terminal groups. As another example, the network device may assign numbers to RRC-connected terminals in the cell, and uses N bits in the second information to indicate the number of the actually scheduled terminal, for example, the number for each terminal is 8 bits, and 24 bits may indicate 3 actually scheduled terminals.

Optionally, the terminal identity is used by the network device or the terminal to determine the group identity to which the terminal belongs; for example, the group identity of the terminal is acquired according to the terminal identity and the protocol. The identity of the terminal may be configured, for example, to the terminal by the network device.

Optionally, the network device configures the group identity of the terminal for the terminal. As an example, the network device sends the group identity of the terminal to the terminal.

In some embodiments, the second information may also not be included in the first information. As an example, the network device sends the first information and the second information separately to the terminal. Optionally, the network device sends the first information via the first DCI, and sends the second information via the PDSCH scheduled by the first DCI.

In some embodiments, the terminal is in the RRC connected state. As an example, the network device sends the first information to the terminal, and the first information is configured to schedule at least two terminals in the RRC connected state. For example, the first information is carried in the first DCI, and the CRC of the first DCI is scrambled using the broadcast identity.

In some embodiments, the terminal may be in an RRC inactive state or an RRC idle state.

In some embodiments, the first information is configured to determine the uplink transmission resource for the terminal to send the uplink data.

In some embodiments, the first information is configured to determine the resource pool for the terminal to send the uplink data. Optionally, one resource pool includes one or a plurality of uplink transmission resources. Optionally, one terminal is configured with one or a plurality of resource pools.

In some embodiments, the resource pools configured for at least two terminals are at least partially identical or entirely different. As an example, the first information indicates that the first terminal and the second terminal are scheduled to send the uplink data; the resource pools include a first resource pool, a second resource pool, and a third resource pool. For example, both the first terminal and the second terminal are configured with the first resource pool and the second resource pool. Alternatively, the first terminal is configured with the first resource pool and the second resource pool; the second terminal is configured with the first resource pool and the third resource pool. Alternatively, the first terminal is configured with the first resource pool, and the second terminal is configured with the third resource pool.

In some embodiments, the first information includes third information. Optionally, the third information is configured to indicate a time-domain offset between a first time-domain position and a second time-domain position; the first time-domain position is a position of a time unit where the first information is sent; the second time-domain position is a position of a time unit of the resource pool for the terminal to send the uplink data.

As an example, the terminal receives the first information sent by the network device, and the first information includes third information; the third information is configured to indicate a time-domain offset between the first time-domain position and the second time-domain position; the terminal determines the second time-domain position based on the first time-domain position and the offset position. The terminal determines the second time-domain position, i.e., determines the resource pool for sending the uplink transmission resource.

In some embodiments, the first information includes fourth information. Optionally, the fourth information is configured to indicate one of the following: at least one resource pool, selected from preconfigured resource pools, for at least one terminal to send the uplink data; or at least one uplink transmission resource, selected from preconfigured resource pools, for at least one terminal to send the uplink data.

In some embodiments, the fourth information and the preconfigured resource are configured for the terminal to determine the resource pool for the terminal to send the uplink data.

In some embodiments, the fourth information is configured for the terminal to determine at least one resource pool selected by the network device from the preconfigured resource pools for the terminal.

In some embodiments, the fourth information is configured for the terminal to determine at least one uplink transmission resource selected by the network device from the preconfigured resource pools for the terminal.

Optionally, the preconfigured resource pool is predefined by the protocol.

Optionally, the preconfigured resource pool is configured for the terminal by the network device. As an example, the network device sends a second signaling to the terminal, and the second signaling is configured to indicate the preconfigured resource pool; the preconfigured resource pool includes one or a plurality of resource pools. Optionally, the second signaling is a high layer signaling. As an example, the network device sends downlink control information to the terminal, and the downlink control information is configured to indicate the preconfigured resource pool.

In some embodiments, the first information includes fifth information. Optionally, the fifth information is configured to indicate an uplink transmission resource in the resource pool corresponding to at least one terminal. Optionally, the fifth information is configured for the terminal to determine the uplink transmission resource of the terminal from the resource pool.

In some embodiments, the network device sends configuration information to the terminal, and the configuration information includes the fifth information. Optionally, the first information and the fifth information are configured to determine the uplink transmission resource for the terminal to send the uplink data.

In some embodiments, the terminal receives the configuration information sent by the network device, and the configuration information includes the fifth information; or, based on a protocol agreement, the fifth information is determined.

In some embodiments, at least one of the third information, the time-domain offset, the fourth information, or the fifth information may not be carried in the first information.

As an example, the network device separately sends the first information and the second information to the terminal. Optionally, the network device sends the first information through the first DCI, and sends the second information through the PDSCH scheduled by the first DCI.

As an example, the network device separately sends the first information and the time-domain offset to the terminal. Optionally, the network device sends the first information through the first DCI, and sends the time-domain offset through the PDSCH scheduled by the first DCI.

As an example, the network device separately sends the first information and the fourth information to the terminal. Optionally, the network device sends the first information through the first DCI, and sends the fourth information through the PDSCH scheduled by the first DCI.

As an example, the network device separately sends the first information and the fifth information to the terminal. Optionally, the network device sends the first information through the first DCI, and sends the fifth information through the PDSCH scheduled by the first DCI.

As an example, the network device separately sends the first information and the fifth information to the terminal. Optionally, the network device sends the first information through the first DCI, and sends the fifth information through the PDSCH scheduled by the first DCI.

Step S2103: the network device sends a first signaling to the terminal.

In some embodiments, the first signaling is, for example, a resource pool configuration signaling.

In some embodiments, the first signaling is used to configure the resource pool for the terminal to send the uplink data. Optionally, the resource pool is configured to determine the uplink transmission resource. Optionally, the uplink transmission resource includes a time-domain resource and/or a frequency domain resource.

In some embodiments, the first signaling is used to configure a preconfigured resource pool for the terminal. Optionally, the preconfigured resource pool includes one or a plurality of resource pools.

In some embodiments, the network device sends the first signaling to a plurality of terminals respectively.

In some embodiments, the first signaling is the high layer signaling. Optionally, the high layer signaling may be an RRC signaling or a Medium Access Control (MAC) signaling.

Step S2104: the terminal determines an uplink transmission resource.

In some embodiments, the terminal determines the uplink transmission resource for the terminal to send the uplink data based on the first information.

In some embodiments, the terminal determines the resource pool for the terminal to send the uplink data based on the first information. Optionally, the resource pool is configured to determine the uplink transmission resource.

In some embodiments, the terminal determines the resource pool for the terminal to send the uplink data based on the first information, including: the terminal determines at least one resource pool for the terminal to send the uplink data based on the fourth information; the at least one resource pool is determined by the network device from the preconfigured resource pools.

As an example, the terminal receives the first information sent by the network device, and the first information includes the fourth information; the fourth information is configured to indicate at least one resource pool, selected from the preconfigured resource pools, for at least one terminal to send the uplink data. For example, the fourth information indicates that the first resource pool selected from the preconfigured resource pool is for the first terminal to send the uplink data, and the second resource pool selected is for the second terminal to send the uplink data; after receiving the first information including the fourth information, the first terminal determines to use the first resource pool to send the uplink data; and/or, after receiving the first information including the fourth information, the second terminal determines to use the second resource pool to send the uplink data.

In some embodiments, the terminal determines the resource pool for the terminal to send the uplink data based on the first information, including: the terminal determines at least one uplink transmission resource for the terminal to send the uplink data based on the fourth information; the at least one uplink transmission resource is determined by the network device from the preconfigured resource pool.

In some embodiments, the terminal determines the uplink transmission resource for the terminal to send the uplink data based on the first information, including: the terminal determines the uplink transmission resource for the terminal to send the uplink data based on the resource pool and the fifth information; the fifth information is configured to indicate the uplink transmission resource corresponding to at least one terminal in the resource pool.

As an example, the terminal receives the first information sent by the access network device, and the first information includes the fourth information; the network device determines the resource pool for the terminal to send the uplink data based on the fourth information; the terminal acquires the fifth information, and determines the uplink transmission resource for the terminal to send the uplink data based on the resource pool and the fifth information. For example, the fifth information is configured to indicate at least one of the following: the first uplink transmission resource in the first resource pool corresponding to the first terminal; the first uplink transmission resource in the first resource pool and the first uplink transmission resource in the second resource pool corresponding to the second terminal; and the first uplink transmission resource in the first resource pool and the second uplink transmission resource in the second resource pool corresponding to the third terminal. After receiving the first information, the first terminal determines that the uplink transmission resource used to send the uplink data is the first uplink transmission resource in the first resource pool; and/or after receiving the first information, the second terminal determines that the uplink transmission resource used to send the uplink data is the first uplink transmission resource in the first resource pool and the first uplink transmission resource in the second resource pool; and/or after receiving the first information, the third terminal determines that the uplink transmission resource for sending the uplink data is the first uplink transmission resource in the first resource pool and the second uplink transmission resource in the second resource pool.

In some embodiments, step S2102 and step S2103 may be executed in exchanged order or simultaneously.

In the embodiments of the present disclosure, step S2102 may be implemented independently as an embodiment; step S2104 may be implemented independently as an embodiment; step S2101 and step S2102 may be implemented independently as an embodiment; step S2102 and step S2104 may be implemented independently as an embodiment; step S2101, step S2102 and step S2104 may be implemented independently as an embodiment; step S2102, step S2103 and step S2104 may be implemented independently as an embodiment; step S2101, step S2102, step S2103 and step S2104 may be implemented independently as an embodiment; and so on.

In some embodiments, step S2101 and step S2103 are optional, and one or more of these steps may be omitted or replaced in different embodiments.

In some embodiments, step S2101, step S2103, and step S2104 are all optional, and one or more of these steps may be omitted or replaced in different embodiments.

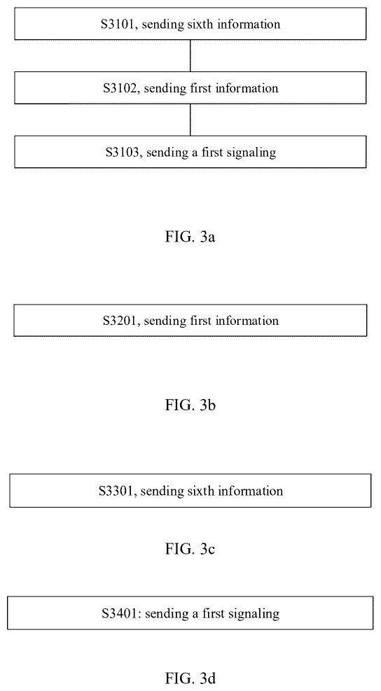

FIG. 3a is a schematic flow diagram of a schedule processing method according to an embodiment of the present disclosure. As shown in FIG. 3a, the embodiment of the present disclosure relates to a schedule processing method, which is performed by a network device. The method includes steps S3101-S3103: step S3101: sixth information is sent.

Optionally, the sixth information is second DCI.

The optional implementation of step S3101 may refer to the optional implementation of step S2101 in FIG. 2 and other related parts in the embodiments involved in FIG. 2, which are not repeated here.

In some embodiments, the network device sends the sixth information to the terminal, but the network device may also send the sixth information to other entities.

Step S3102: first information is sent.

Optionally, if the first information is carried and sent in a downlink data channel, the network device performs step S3101; or, if the first information is carried and sent in the first DCI, the network device does not perform step S3101.

The optional implementation of step S3102 may refer to the optional implementation of step S2102 in FIG. 2 and other related parts in the embodiments involved in FIG. 2, which are not repeated here.

In some embodiments, the network device sends the first information to the terminal, but the network device may also send the first information to other entities.

Step S3103: a first signaling is sent.

Optionally, the first signaling is a high layer signaling.

The optional implementation of step S3103 may refer to the optional implementation of step S2103 in FIG. 2 and other related parts in the embodiments involved in FIG. 2, which are not repeated here.

In some embodiments, the network device sends the first signaling to the terminal, but the network device may also send the first signaling to other entities.

In some embodiments, step S3102 and step S3103 may be executed in exchanged order or simultaneously. For example, the network device first performs S3103 and then performs S3102. As another example, the network device simultaneously performs step S3103 and step S3102.

In some embodiments, step S3102 may be implemented independently as an embodiment; step S2301 and step S3102 may be implemented independently as an embodiment; step S3101, step S3102, and step S3103 may be implemented independently as an embodiment; and so on.

In some embodiments, step S3101 and step S3103 are optional, and one or more of these steps may be omitted or replaced in different embodiments.

FIG. 3b is a schematic flow diagram of a schedule processing method according to an embodiment of the present disclosure. As shown in FIG. 3b, the embodiment of the present disclosure relates to a schedule processing method, which is performed by a network device. The method includes S3201:
step S3201: first information is sent.

Optionally, the first information is carried in a downlink data channel for transmission, or the first information is carried in the first DCI for transmission; and so on.

The optional implementation of step S3201 may refer to the optional implementation of step S2102 in FIG. 2 or step S3102 in FIG. 3a, and other related parts in the embodiments involved in FIG. 2 and FIG. 3a, which are not repeated here.

FIG. 3c is a schematic flow diagram of a schedule processing method according to an embodiment of the present disclosure. As shown in FIG. 3c, the embodiment of the present disclosure relates to a schedule processing method, which is performed by a network device. The method includes step S3301:
step S3301: sixth information is sent.

The optional implementation of step S3301 may refer to the optional implementation of step S2101 in FIG. 2 or step S3101 in FIG. 3a, and other related parts in the embodiments involved in FIG. 2 and FIG. 3a, which are not repeated here.

FIG. 3d is a schematic flow diagram of a schedule processing method according to an embodiment of the present disclosure. As shown in FIG. 3d, the embodiment of the present disclosure relates to a schedule processing method, which is performed by a network device. The method includes step S3401:
step S3401: a first signaling is sent.

The optional implementation of step S3401 may refer to the optional implementation of step S2103 in FIG. 2, or step S3103 in FIG. 3a, and other related parts in the embodiments involved in FIG. 2 and FIG. 3a, which are not repeated here.

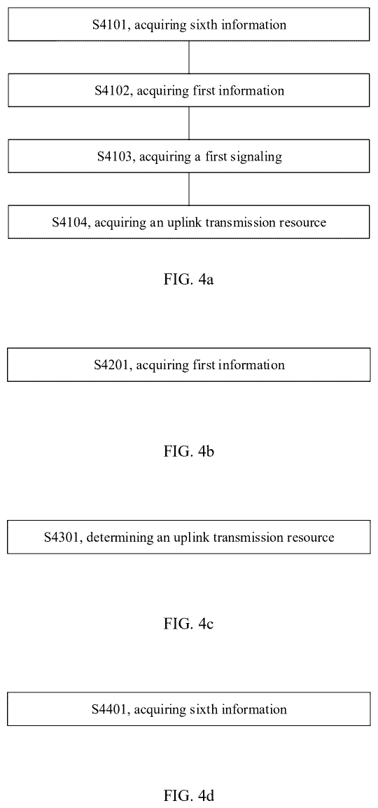

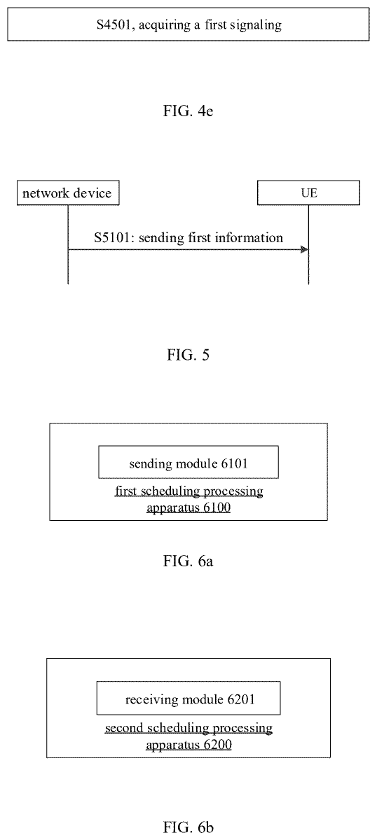

FIG. 4a is a schematic flow diagram of a schedule processing method according to an embodiment of the present disclosure. As shown in FIG. 4a, the embodiment of the present disclosure relates to a schedule processing method, which is performed by a terminal. The method includes steps S4101-S4104: step S4101: sixth information is acquired.

Optionally, the sixth information is the second DCI.

The optional implementation of step S4101 may refer to the optional implementation of step S2101 in FIG. 2 and other related parts in the embodiments involved in FIG. 2, which are not repeated here.

In some embodiments, the terminal receives the sixth information from the network device, but may also receive the sixth information from other entities.

In some embodiments, step S4101 is omitted.

Step S4102: first information is acquired.

The optional implementation of step S4102 may refer to the optional implementation of step S2102 in FIG. 2 and other related parts in the embodiments involved in FIG. 2, which are not repeated here.

In some embodiments, the terminal receives the first information from the network device, but may also receive the first information from other entities.

Step S4103: a first signaling is acquired. Optionally, the first signaling is a high layer signaling.

The optional implementation of step S4103 may refer to the optional implementation of step S2103 in FIG. 2 and other related parts in the embodiments involved in FIG. 2, which are not repeated here.

In some embodiments, the terminal receives the first signaling from the network device, but may also receive the first signaling from other entities.

In some embodiments, step S4103 is omitted, and the terminal autonomously implements a function indicated by the high layer signaling.

Step S4104: an uplink transmission resource is determined.

In some embodiments, the terminal determines the uplink transmission resource for the terminal to send the uplink data based on the first information.

In some embodiments, the terminal determines the resource pool for the terminal to send the uplink data based on the first information. Optionally, the resource pool is configured to determine the uplink transmission resource.

The optional implementation of step S4104 may refer to the optional implementation of step S2104 in FIG. 2 and other related parts in the embodiments involved in FIG. 2, which are not repeated here.

In some embodiments, step S4102 and step S4103 may be executed in exchanged order or simultaneously.

In the embodiment of the present disclosure, step S4102 may be implemented independently as an embodiment; step S4104 may be implemented independently as an embodiment; step S4101 and step S4102 may be implemented independently as an embodiment; step S4102 and step S4104 may be implemented independently as an embodiment; step S4101, step S4102, and step S4104 may be implemented independently as an embodiment; step S4102, step S4103, and step S4104 may be implemented independently as an embodiment; step S4101, step S4102, step S4103, and step S4104 may be implemented independently as an embodiment; and so on.

In some embodiments, step S4101 and step S4103 are optional, and one or more of these steps may be omitted or replaced in different embodiments.

In some embodiments, steps S4101, S4103, and S4104 may all be optional. One or more of these steps may be omitted or substituted in different embodiments.

FIG. 4b is a schematic flow diagram of a schedule processing method according to an embodiment of the present disclosure. As shown in FIG. 4b, the embodiment of the present disclosure relates to a schedule processing method, which is performed by a terminal. The method includes step S4201:
step S4201: first information is acquired.

The optional implementation of step S4201 may refer to the optional implementation of step S2102 in FIG. 2, or step S4102 in FIG. 4a, and other related parts in the embodiments involved in FIG. 2 and FIG. 4a, which are not repeated here.

FIG. 4c is a schematic flow diagram of a schedule processing method according to an embodiment of the present disclosure. As shown in FIG. 4c, the embodiment of the present disclosure relates to a schedule processing method, which is performed by a terminal. The method includes step S4301:
step S4301: an uplink transmission resource is determined.

The optional implementation of step S4301 may refer to the optional implementation of step S2104 in FIG. 2, or step S4104 in FIG. 4a, and other related parts in the embodiments involved in FIG. 2 and FIG. 4a, which are not repeated here.

FIG. 4d is a schematic flow diagram of a schedule processing method according to an embodiment of the present disclosure. As shown in FIG. 4d, the embodiment of the present disclosure relates to a schedule processing method, which is performed by a terminal. The method includes step S4401:
step S4401: sixth information is acquired.

The optional implementation of step S4401 may refer to the optional implementation of step S2101 in FIG. 2, or step S4101 in FIG. 4a, and other related parts in the embodiments involved in FIG. 2 and FIG. 4a, which are not repeated here.

FIG. 4e is a schematic flow diagram of a schedule processing method according to an embodiment of the present disclosure. As shown in FIG. 4e, the embodiment of the present disclosure relates to a schedule processing method, which is performed by a terminal. The method includes step S4501:
Step S4501: a first signaling is acquired.

The optional implementation of step S4501 may refer to the optional implementation of step S2103 in FIG. 2, or step S4103 in FIG. 4a, and other related parts in the embodiments involved in FIG. 2 and FIG. 4a, which are not repeated here.

FIG. 5 is a schematic flow diagram of a schedule processing method according to an embodiment of the present disclosure. As shown in FIG. 5, the embodiment of the present disclosure relates to a schedule processing method, which is used for a schedule processing system 100. The method includes step 5101:
step S5101: a network device 502 sends first information to a terminal or UE 504.

The optional implementation of step S5101 may refer to the optional implementation of step S2102 in FIG. 2, step S4102 in FIG. 4a, and other related parts in the embodiments involved in FIG. 2 and FIG. 4a, which are not repeated here.

In some embodiments, the above method may include the method described in the above-mentioned embodiments related to the schedule processing system 100, the terminal, and the network device, which are not repeated here.

The embodiment of the present disclosure relates to the schedule processing method.

The method includes the following steps:

In some embodiments, the base station sends first scheduling information to schedule a plurality of UEs to send uplink information.

Optionally, the sending manner of the first scheduling information is multicast or broadcast. The plurality of UEs or all UEs in one cell may receive the first scheduling information.

Optionally, the first scheduling information is multicast downlink control information, where the CRC used for transmission of the downlink control information is scrambled with the group identity of the terminal. The group identity of the terminal is the identity of the group of terminals corresponding to the downlink control information. In this case, the plurality of UEs scheduled by this downlink control information is the plurality of UEs contained in the terminal group.

Optionally, the first scheduling information includes UE indication information, which is configured to indicate which UEs in the group of terminals are scheduled. For example, there are 16 UEs in total in the group of terminals; the UE indication information includes 16 bits, which may correspond one-to-one to indicate which UEs in the group are the UEs that are actually scheduled.

Optionally, the first scheduling information is broadcast downlink control information, and the CRC used for the downlink control information is scrambled with a broadcast identity predefined by the protocol. That is, all UEs in the cell may receive the downlink control information.

Optionally, the first scheduling information includes UE indication information, which is configured to indicate which UE groups are scheduled. For example, the UE indication information includes 8 bits, each bit corresponding to one UE group. The UE determines whether it is scheduled according to the UE group it belongs to. There are multiple ways for a terminal to determine the UE group of the terminal; for example, the base station configures a UE group ID for the UE via a high layer signaling. As another example, the UE calculates the UE group ID based on its own terminal group identity (such as C-RNTI).

Optionally, the first scheduling information is applied to a UE in RRC connected state.

Optionally, the first scheduling information is sent in a downlink data channel, and the downlink data channel is scheduled by the downlink control information.

Optionally, in the downlink data channel, the identities of the plurality of UEs that are scheduled or the group identities of the UE groups that are scheduled are directly carried.

The following describes how the plurality of UEs, after receiving the first scheduling information, determine on which uplink resource they are to send the uplink information.

In some embodiments, the UE determines the uplink transmission resource for sending the uplink information based on the first scheduling information.

Optionally, the base station preconfigures, via the high layer signaling, a resource pool for the plurality of UEs to send the uplink information. One or a plurality of different resource pools may be configured.

Optionally, in the first scheduling information, the base station indicates a time-domain offset between the position of the time unit where the first scheduling information is located and the position of the resource pool used for sending the uplink information.

Optionally, in the first scheduling information, the base station indicates one or a plurality of resource pools, selected from a plurality of preconfigured resource pools, for sending the uplink information.

Optionally, the UE may find the uplink transmission resource corresponding to the UE itself from the resource pool for transmitting the uplink information, according to a corresponding relationship predefined by the protocol or preconfigured by the base station.

In some embodiments, the first scheduling information may be the first information in the foregoing embodiments; the uplink information may be the uplink data in the foregoing embodiments; the group identity of the terminal may be the identity of the UE in the foregoing embodiments; the downlink control information may be the first DCI in the foregoing embodiments; the UE indication information may be the second information in the foregoing embodiments; the group ID may be the group ID in the foregoing embodiments; the downlink control information may be the second DCI in the foregoing embodiments; the protocol predefined configuration may be the protocol agreement in the foregoing embodiments; the corresponding relationship may be the fifth information in the foregoing embodiments.

In the embodiment of the present disclosure, some or all steps and their optional implementations may be arbitrarily combined with some or all steps in other embodiments, and may also be arbitrarily combined with optional implementations in other embodiments.

The embodiment of the present disclosure further provides an apparatus for implementing any of the above methods. For example, an apparatus is provided that includes units for implementing each step executed by the terminal in any of the above methods. Another example is an apparatus that includes units for implementing each step executed by the network device in any of the above methods.

It should be understood that division of the units in the foregoing apparatus is merely logical function division, and in actual implementation, all or some of the units may be integrated into one physical entity, or may be physically separated. In addition, the units in the apparatus may be implemented in a form of software invoked by a processor, for example, the apparatus includes a processor, the processor is connected to a memory, the memory stores computer instructions, and the processor invokes the computer instructions stored in the memory, to implement any one of the foregoing methods or implement functions of the units in the foregoing apparatus. The processor may be a general-purpose processor, such as a Central Processing Unit (CPU) or a microprocessor, and the memory may be an internal memory of the apparatus or an external memory. Alternatively, the units in the apparatus may be implemented in a form of a hardware circuit, and some or all functions of the units may be implemented by designing the hardware circuit, and the hardware circuit may be understood as one or more processors; for example, in an implementation, the hardware circuit is an application-specific integrated circuit (ASIC), and functions of some or all the units are implemented by designing a logical relationship between elements in the circuit; and for another implementation, the hardware circuit may be implemented by using a programmable logic device (PLD), and by using a field programmable gate array (FPGA) as an example, the hardware circuit may include a large quantity of logic gate circuits, and a connection relationship between the logic gate circuits is configured by using a configuration file, to implement functions of some or all the units. All units of the foregoing apparatus may be implemented in a form of software invoked by a processor, or may be implemented in a form of a hardware circuit, or may be partially implemented in a form of software invoked by a processor, and a remaining part is implemented in a form of a hardware circuit.

In the embodiments of the present disclosure, the processor is a circuit having a signal processing capability, and in one implementation, the processor may be a circuit having instruction reading and running capabilities, such as a central processing unit (Central Processing Unit, CPU)), a microprocessor, a graphics processing unit (graphics processing unit, GPU) (which may be understood as a microprocessor), or a digital signal processor (digital signal processor, DSP)); in another implementation, the processor may implement a certain function through a logical relationship of a hardware circuit, and the logical relationship of the hardware circuit is fixed or reconfigurable, for example, the processor is a hardware circuit implemented by an application-specific integrated circuit (application-specific integrated circuit, ASIC)) or a programmable logic device (programmable logic device, PLD)), such as an FPGA. In the reconfigurable hardware circuit, a process in which the processor loads the configuration document to implement configuration of the hardware circuit may be understood as a process in which the processor loads instructions to implement functions of some or all of the foregoing units. In addition, it can also be a hardware circuit designed for artificial intelligence, which can be understood as a ASIC, such as a Neural Network Processing Unit (NPU)), a Tensor Processing Unit (TPU)), a Deep learning Processing Unit (DPU)), etc.

FIG. 6a is a schematic structural diagram of a first schedule processing apparatus provided in the embodiments of the present disclosure. As shown in FIG. 6a, the first schedule processing apparatus 6100 includes: a sending module 6101, configured to send first information, where the first information is configured to schedule at least two terminals to send uplink data. Optionally, the sending module 6101 is used to perform the steps related to sending in the above-described method embodiments associated with the network device; for example, steps related to S3101, S3102, and/or S3103.

FIG. 6b is a schematic structural diagram of a second schedule processing apparatus provided in the embodiments of the present disclosure. As shown in FIG. 6b, the second schedule processing apparatus 6200 includes: a receiving module 6201, configured to acquire first information, where the first information is configured to schedule at least two terminals to send uplink data. Optionally, the receiving module 6201 is used to perform the steps related to reception in the above-described method embodiments associated with terminals; for example, steps related to S4101, S4102, and/or S4103.

Optionally, the second schedule processing apparatus 6200 may further include a processing module; the processing module is used to perform the steps related to determination and/or processing in the above-described method embodiments associated with the terminal; for example, steps related to S4104.

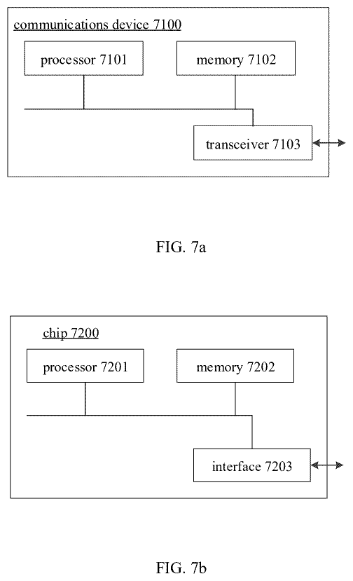

FIG. 7a is a block diagram of a communications device 7100 according to an embodiment of this disclosure. The communications device 7100 may be a network device, a terminal, a chip, a chip system, a processor, or the like that supports the network device in implementing any one of the foregoing methods, or a chip, a chip system, a processor, or the like that supports the terminal in implementing any one of the foregoing methods. The communication device 7100 may be used to implement the methods described in the method embodiments above, as specifically described therein.

As shown in FIG. 7a, the communication device 7100 includes one or more processors 7101, and the processor 7101 is configured to invoke computer instructions to enable the communication device 7100 to perform any one of the foregoing methods.

Optionally, the communication device 7100 further includes one or more memories 7102 configured to store instructions. In an optional embodiment, all or a part of the memory 7102 may alternatively be located outside the communication device 7100.

Optionally, the communication device 7100 further includes one or a plurality of transceivers 7103. When the communication device 7100 includes one or a plurality of transceivers 7103, communication steps such as sending and receiving in the above methods are performed by the transceivers 7103, and other steps are performed by the processor 7101.

The communication device 7100 described in the above embodiments may be a network device or a terminal, but the scope of the communication device 7100 described in the present disclosure is not limited thereto, and the structure of the communication device 7100 is not limited by FIG. 7a. The communication device may be an independent device or may be a part of a larger device. For example, the communications device may be: (1) an independent integrated circuit IC, or a chip, or a chip system or subsystem; (2) a set having one or more ICs, where optionally, the IC set may also include a storage component configured to store data and a computer program; an (3)ASIC, for example, a modem; (4) a module that may be embedded in another device; (5) a receiver, a terminal device, an intelligent terminal device, a cellular phone, a wireless device, a handset, a mobile unit, a vehicle-mounted device, a network device, a cloud device, an artificial intelligence device, or the like; or (6) another device.

FIG. 7b is a block diagram of a chip 7200 according to an embodiment of the present disclosure. For a case in which the communication device 7200 may be a chip or a chip system, refer to a schematic diagram of a structure of a chip 7200 shown in FIG. 7b.

The chip 7200 includes one or more processors 7201, and the processor 7201 is configured to invoke computer instructions to enable the chip 7200 to perform any one of the foregoing methods.

Optionally, the chip 7200 further includes one or more memories 7202 configured to store computer instructions. In alternative embodiments, all or a portion of memory 7202 may be external to chip 7200.

Optionally, the chip 7200 further includes one or more interfaces 7203, the interface 7203 is connected to the memory 7202, the interface 7203 may be configured to receive a signal from the memory 7202 or another apparatus, and the interface 7203 may be configured to send a signal to the memory 7202 or another apparatus. For example, the interface 7203 may read computer instructions stored in the memory 7202, and send the computer instructions to the processor 7201.

In some embodiments, terms such as an interface, an interface circuit, a transceiver pin, and a transceiver may be replaced with each other.

The present disclosure further provides a non-transitory readable storage medium, where the readable storage medium stores computer instructions, and when the computer instructions are run on the communication device 7100, the communication device 7100 is enabled to perform any one of the foregoing methods. Optionally, the computer-readable storage medium may be a non-transitory computer-readable storage medium, or may be a transitory computer-readable storage medium.

The present disclosure further provides a computer program product that, when executed by the communication device 7100, causes the communication device 7100 to perform any of the above methods.

1. A schedule processing method, performed by a network device, comprising:
sending first information,
wherein the first information is configured to schedule at least two terminals to send uplink data.

2. The schedule processing method according to claim 1, wherein sending the first information comprises one of:
broadcasting the first information, and
multicasting the first information.

3. The schedule processing method according to claim 1, wherein sending the first information comprises:
sending first downlink control information (DCI),
wherein the first DCI comprises the first information.

4. The schedule processing method according to any claim 1, wherein a cyclic redundancy check (CRC) of the first DCI uses an identity for scrambling;
wherein the identity is one of:
a group identity configured to indicate a group of terminals corresponding to the first DCI, and the at least two terminals are divided into one group or a plurality of groups, and
a broadcast identity.

5. (canceled)

6. The schedule processing method according to any claim 1, wherein the first information comprises second information, wherein the second information is configured to indicate at least one of:
one group or a plurality of groups of terminals requiring scheduling, and
the terminal requiring scheduling.

7. The schedule processing method according to any claim 1, wherein the terminal is in a Radio Resource Control (RRC) connected state.

8. The schedule processing method according to any claim 1, wherein sending the first information comprises:
sending the first information based on a downlink data channel.

9. The schedule processing method according to claim 8, further comprising:
sending second DCI, wherein the second DCI is configured to schedule the downlink data channel;
wherein the downlink data channel carries at least one of:
terminal identities of at least two terminals scheduled, and
a group identity of one group of terminals scheduled or group identities of a plurality of groups of terminals scheduled.

10. (canceled)

11. The schedule processing method according to claim 1, wherein the first information is configured to determine one of:
an uplink transmission resource for the terminal to send the uplink data, and
a resource pool for the terminal to send the uplink data.

12. The schedule processing method according to claim 1, further comprising:
sending a high layer signaling,
wherein the high layer signaling is used to configure a resource pool for the terminal to send the uplink data, and
wherein the resource pool is configured to determine an uplink transmission resource.

13. The schedule processing method according to claim 11, wherein one of the terminals is configured with one or a plurality of resource pools;
wherein the resource pools configured for the at least two terminals are at least partially identical or entirely different.

14. (canceled)

15. The schedule processing method according to claim 11, wherein the first information comprises third information;
wherein the third information is configured to indicate a time-domain offset between a first time-domain position and a second time-domain position;
wherein the first time-domain position is a position of a time unit where the first information is sent; and
wherein the second time-domain position is a position of a time unit of the resource pool for the terminal to send the uplink data.

16. The schedule processing method according to claim claim 11, wherein the first information comprises fourth information, wherein the fourth information is configured to indicate one of:
at least one resource pool, selected from preconfigured resource pools, for at least one terminal to send the uplink data, and
at least one uplink transmission resource, selected from preconfigured resource pools, for at least one terminal to send the uplink data.

17. The schedule processing method according to claim 11, further comprising:
sending configuration information, wherein the configuration information comprises fifth information,
wherein the fifth information is configured to indicate the uplink transmission resource in the resource pool corresponding to at least one terminal.

18. A schedule processing method, performed by a terminal, comprising:
acquiring first information, wherein the first information is configured to schedule at least two terminals to send uplink data.

19. The schedule processing method according to claim 18, wherein acquiring the first information comprises one of:
acquiring the first information that is broadcast; or
acquiring the first information that is multicast;
wherein acquiring the first information comprises:
acquiring first DCI,
wherein the first DCI comprises the first information;
wherein a CRC of the first DCI uses an identity for scrambling.

20.-27. (canceled)

28. The schedule processing method according to any claim 18, further comprising one of:
determining, based on the first information, an uplink transmission resource for the terminal to send the uplink data; or determining, based on the first information, a resource pool for the terminal to send the uplink data.

29.-33. (canceled)

34. The schedule processing method according to claim 28, wherein determining, based on the first information, the uplink transmission resource for the terminal to send the uplink data comprises:
determining, based on the resource pool and fifth information, the uplink transmission resource for the terminal to send the uplink data,
wherein the fifth information is configured to indicate the uplink transmission resource in the resource pool corresponding to at least one terminal;
wherein the schedule processing method further comprises at least one of:
receiving configuration information sent by a network device, wherein the configuration information comprises the fifth information; and
determining the fifth information based on a protocol agreement.

35.-37. (canceled)

38. A communication device, comprising:
one or a plurality of processors,
wherein the processor is configured to invoke computer instructions cause the communication device to send first information,
wherein the first information is configured to schedule at least two terminals to send uplink data.

39.-40. (canceled)

41. A communication device, comprising:
one or a plurality of processors,
wherein the processor is configured to invoke computer instructions cause the communication device to execute the schedule processing method according to claim 18.
